(19) United States
(12) Patent Application Publication
(10) Pub. No.: US 2009/0139964 A1
(43) Pub. Date: Jun. 4, 2009

(54) WIRE-RECEIVING MECHANISM

(75) Inventors: Tzuo-Liang Luo, Hsinchu (TW); Yang-Xin Lin, Hsinchu (TW); Chin-Muo Hsu, Hsinchu (TW); Feng-Ming Ou, Hsinchu (TW); En-Sheng Chung, Hsinchu (TW); Jui-Kuan Lin, Hsinchu (TW); Ching-Yuan Lin, Hsinchu (TW)

Correspondence Address: Muncy, Geissler, Olds & Lowe, PLLC, P.O. BOX 1364, FAIRFAX, VA, 22038-1364, US

(73) Assignee: Industrial Technology Research Institute

(21) Appl. No.: 12/060,047

(22) Filed: Mar. 31, 2008

(30) Foreign Application Priority Data
Dec. 3, 2007 (TW) 096145841

(51) Int. Cl. B23K 9/133; B23H 7/10

(52) U.S. Cl. 219/69.12; 204/225

(57) ABSTRACT

A wire-receiving mechanism for holding electrical wire used to cut or burn through a metal work piece in wire electrical discharge machines (WEDMs) is disclosed. A passive wheel and an active wheel are disposed side by side with one another in a case body, the active wheel being capable of causing the passive wheel to rotate, wherein one side of the passive wheel has a driving unit defined thereon. The driving unit is disposed to penetrate through one side of the case body, and includes a driving member disposed to one side of the case body, an action member connected to the driving member and a sliding member connected to the action member for pushing the passive wheel, wherein a pretension spring is disposed at one side of the sliding member for controlling the gap between the passive wheel and the active wheel such that the processing wires can be stably held and conveyed.

### BACKGROUND OF THE INVENTION

1. Field of the Invention

The present invention relates generally to a metal machining technique, and more particularly to a wire-receiving mechanism applicable to a wire electrical discharge machine used in wire electrical discharge machining (WEDM).

2. Description of Related Art:

The wire electrical discharge machining (WEDM) technique is a technique that is applicable to micro-machining used to cut through metal to produce a desired shape, wherein a voltage is applied between a processing wire and an electrically-conductive, metallic work piece, wherein, through stable conveyance of the processing wire, spark discharges occur, thereby melting the work piece and cutting a desired shape. Because there are no cutting forces used, small work pieces can be cut without damaging the work piece. Thus, the WEDM is preferably to be applied in micro-system machining.

As product sizes scale down to the nano-scale range, micro-machining techniques are also impacted. For example, the diameter of the processing wire of a wire electrical discharge machine is reduced when work pieces become smaller. Generally, the diameter of the processing wires ranges from 0.15 mm down to 0.02 mm and so on. Therefore, the design in holding and conveying the processing wire of a wire electrical discharge machine has become quite important.

A conventional wire electrical discharge machine comprises a wire-sending mechanism located on an upper end of the machine, a cutting platform located in the middle of the machine, and a wire-receiving mechanism located on the lower end of the machine. To machine a work piece, the processing wire from the wire-sending mechanism passes through the cutting platform and reaches the wire-receiving mechanism. Electrical discharges occur in the gap between the processing wire and the work piece so as to machine the work piece. Taiwan Patent Publication No. 323565, No. 373341, No. 389713 and certificate No. 281422 disclose techniques related to wire electrical discharge machining.

As shown in FIGS. 6A and 6B, the wire-receiving mechanism of a conventional wire electrical discharge machine comprises a holding mechanism 1, which comprises two eccentric wheels 10, 11 disposed side by side. A gap 12 is formed between the two eccentric wheels 10, 11 for holding and converying the processing wire 13. Meanwhile, the ecentric wheels 10, 11 respectively have gear wheels 100, 110. The gear wheels 100, 110 are engaged with each other. Driven by a motor (not shown), a rod 14 causes the gear wheel 100 of the eccentric wheel 10 to rotate. Through the engagement of the gear wheels 100, 110, both the eccentric wheels 10, 11 are rotated.

The gap between the eccentric wheels needs to be manually adjsuted by users so as to hold processing wires of different diameters and ensure stable conveyance of wires. Generally, the gap between the eccentric wheels can be directly adjusted or adjusted by mechanical shift.

However, when the gap between the two eccentric wheels is directly adjusted, the engagement spacing between the two gear wheels 100, 110 can become uneven due to insufficient roundness of the two eccentric wheels 10, 11 or bearing assembly error. Thus, not only is the engagement accuracy of the gear wheels 100, 110 reduced but also the holding force of the processing wire 13 becomes unsuitable, which can further cause the feed rate of the processing wire 13 to become variable, sometimes faster and sometimes slower. Thus, the processing wire 13 may slip on the wheel surfaces of the two eccentric wheels 10, 11 and may even break. Therefore, the quality of the machining surface of the work piece can be adversely affected, thus resulting in lower product yield or quality.

Meanwhile, in a wire electrical discharge machine having a threading module, if the processing wire 13 is easily breakable and the diameter of the cutting wire utilized needs to be changed according to the work piece to be machined, as is often the case, then the threading success rate may not be high, thereby increasing the load of the threading module. Further, the adjustable distance is quite limited when the gap between the two eccentric wheels 10, 11 is directly adjusted, and thus cannot meet the demands for machining of work pieces having complicated shapes. Also, as the eccentric wheels 10, 11 are controlled by a motor, the holding pre-force is difficult to control, and if the processing wire is held too tightly, friction force will become too great and slow or break the processing wire; or, alternately, if the holding pre-force is not tight enough, the processing wire may swing or slip.

If the gap between the eccentric wheels is changed by mechanical shift, the gap can become much larger compared with the above method. However, if processing wires 13 having two or more diameters in the same process are used, the wire electrical discharge machine must be stopped before adjusting the gap by using mechanical shift. After the processing wire is threaded again, the processing wire 13 from the wire-sending mechanism passes through the cutting platform and reaches the wire-receiving mechanism. As a result, the process becomes quite complicated. Accordingly, the industry tends to use only one kind of processing wire per cutting process; that is, a cutting process does not use processing wires having two or more diameters in the same process.

Furthermore, no matter which one of the above-described adjusting methods is used, in that the eccentric wheels can become loose due to abrasion or other factors, the gap between the eccentric wheels needs to be manually adjusted again after a period of time.

Therefore, although the wire electrical discharge machine is suitable to be applied in a micro-machining process, it has some drawbacks in holding and conveying the processing wire. In addition, a variety of processing wires cannot be provided in the same process to machine work pieces having complicated shapes. Thus, either the processing costs and time are increased, or the industrial applicability is reduced.

Therefore, finding a way to overcome the above-mentioned drawbacks has become highly desirable in the industry.

### SUMMARY OF THE INVENTION

According to the above drawbacks, an objective of the present invention is to provide a wire-receiving mechanism for stable wire conveyance.

Another objective of the present invention is to provide a wire-receiving mechanism that can automatically adjust the holding force.

A further objective of the present invention is to provide a wire-receiving mechanism that can conveniently accommodate a change to a wire of a different diameter.

A further objective of the present invention is to provide a wire-receiving mechanism that can save process time.

A further objective of the present invention is to provide a wire-receiving mechanism that can automatically adjust the gap between the eccentric wheels.

In order to attain the above and other objectives, the present invention provides a wire-receiving mechanism for receiving the processing wire of a wire electrical discharge machine, the mechanism comprising: a case body having a first side and an opposed second side; a passive wheel disposed inside the case body; an active wheel disposed inside the case body at one side of the passive wheel, the active wheel being capable of causing the passive wheel to rotate; a driving unit disposed to penetrate through the first side of the case body, wherein the driving unit has a driving member exposed from the first side, an action member connected to the driving member and a sliding member connected to the action member for pushing the passive wheel, thereby controlling the gap between the passive wheel and the active wheel for holding the processing wire; and a pretension spring disposed at one side of the sliding member and abutted against the sliding member through one end thereof so as to provide elasticity that allows the passive wheel to move toward the first side of the case body.

In one embodiment, the active wheel is axially connected to the case body and the pretension spring is abutted against the second side of the case body through the other end thereof. The driving unit has a connecting rod, one end of which is connected to the action member and the other end of which is axially connected to the sliding member. In another embodiment, a micro-movement member is provided that is axially connected to the sliding member and disposed on the upper and lower ends of the active wheel. The connecting rod is axially connected to the action member, the sliding member and the micro-movement member. Preferably, the micro-movement member is a sliding block. In another embodiment, the wire-receiving mechanism further comprises a sliding structure for allowing the sliding member to slide, wherein the sliding structure comprises: sliding rails respectively disposed on the top and bottom interior surfaces of the case body, and a sliding slot disposed in the sliding member. Alternatively, the sliding structure comprises a pin disposed in the micro-movement member and a slot disposed in the sliding member. In the above-described wire-receiving mechanism, a status adjusting unit can be provided and disposed at the second side of the case body.

It should be noted that the sliding structure is used for sliding of the sliding member, wherein the disposing of the sliding rails can prevent swinging of the sliding member so as to make the sliding member capable of moving linearly. In another embodiment, the sliding rails and sliding slot may be omitted or replaced by other equivalent elements or structures. For example, if the sliding member and the shape of the case body are matched with each other and the enclosed case body can limit swinging of the sliding member, the sliding member also can slide, or the driving member can be designed to make the sliding member linearly move in a unique direction, or the passive wheel can be pushed by moving the sliding member, and the pretension spring can compensate for any error. Thus, the sliding member can also slide.

In one embodiment, the wire-receiving mechanism comprises a micro-movement member axially connected to the sliding member, wherein the status adjusting unit is disposed at one side of the micro-movement member for adjusting the micro-movement member so as to make the passive wheel and the active wheel parallel with each other. The status adjusting unit can comprise a bolt axially connected to the micro-movement member, a fixing bolt nut threaded on the bolt and located inside the second side of the case body, and an adjusting bolt nut threaded on the bolt and located outside the second side of the case body. Alternatively, a bolt hole can be formed at the second side and the status adjusting unit is disposed to penetrate through the bolt hole, the status adjusting unit comprising a bolt axially connected to the micro-movement member and fixed by the bolt hole, and an adjusting bolt nut being threaded on the bolt and located outside the second side.

In one embodiment, the wire-receiving mechanism comprises a micro-movement member axially connected to the sliding member and a pretension spring can be disposed between the sliding member and the micro-movement member.

In another embodiment, the wire-receiving mechanism comprises a control unit electrically connected to the driving unit, wherein the wire electrical discharge machine has a motor for driving the active wheel, and the control unit comprises a rotation speed control portion electrically connected to the motor and a holding force control portion electrically connected to the driving member. In addition, an operation interface can be provided and electrically connected to the control unit for providing a rotation speed command, wherein the rotation speed control portion comprises a decoder for receiving the rotation speed signal of the motor and generating a decoding signal, a first controller for receiving the decoding signal and the rotation speed command and generating a control signal, and a first driver for receiving the control signal so as to drive the motor. The first controller can be a proportional, integral, derivative controller (PID controller). The holding force control portion comprises a current detector for detecting the motor current and generating a current signal, a manipulator for receiving the rotation speed command and generating a position command, a second controller for receiving the current signal and the position command and generating a control signal, and a second driver for receiving the control signal so as to drive the driving member.

Compared with the prior art that manually adjusts the gap between eccentric wheels for holding processing wires of different diameters, the present invention controls the gap between the active wheel and the passive wheel through the driving unit so as to generate a suitable holding force such that processing wires can be stably conveyed. Meanwhile, a suitable holding force can efficiently protect the processing wires from breaking. Therefore, the present invention provides an even and stable holding force that ensures a stable wire conveyance. Meanwhile, wires of different diameters can be applied in the same cutting process by automatically adjusting the gap between the active wheel and the passive wheel. Thus, the present invention improves the process convenience, ensures efficient and stable wire conveyance and saves processing time and cost.

### BRIEF DESCRIPTION OF DRAWINGS

FIG. 1 is a perspective diagram of a wire-receiving mechanism according to an embodiment of the present invention;

FIG. 2A is a perspective diagram of a wire-receiving mechanism according to another embodiment of the present invention;

FIGS. 2B and 2C are partial, close-up front views of part of each wheel and the gap therebetween of the wire-receiving mechanism of FIG. 2A or FIG. 3A;

FIGS. 3A and 3B are action diagrams of the wire-receiving mechanism of FIG. 2A as seen from a front perspective;

FIGS. 4A and 4B are partial, close-up front views of part of each wheel and the gap therebetween of the wire-receiving mechanism FIG. 2A or FIG. 3A;

FIG. 5A is a perspective diagram of a wire-receiving mechanism according to another embodiment of the present invention;

FIG. 5B is a functional block diagram of the control unit of FIG. 5A; and

FIGS. 6A and 6B are, respectively, perspective and side diagrams showing a conventional mechanism for holding a processing wire.

### DETAILED DESCRIPTION OF PREFERRED EMBODIMENTS

The following illustrative embodiments are provided to illustrate the disclosure of the present invention; these and other advantages and effects will be apparent to those skilled in the art upon reading the disclosure of this specification.

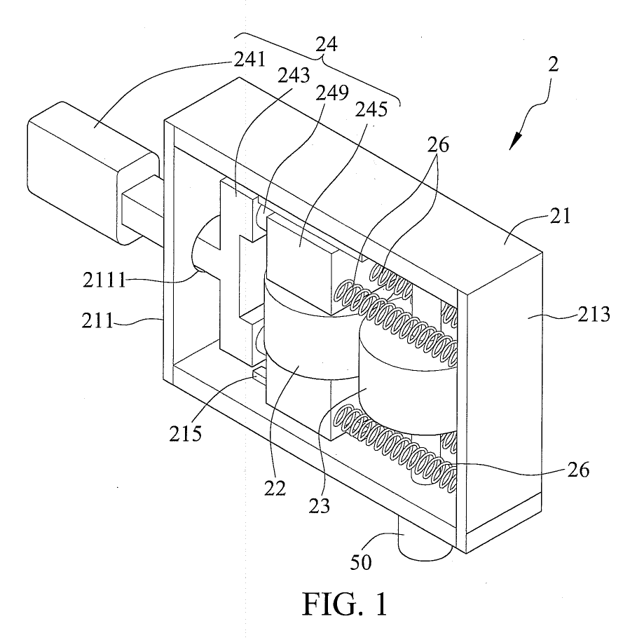

FIG. 1 is a diagram showing a wire-receiving mechanism according to an embodiment of the present invention. Referring to FIG. 1, a wire-receiving mechanism 2 is provided that can be applied to a wire electrical discharge machine (not shown) for holding a processing wire (not shown) thereof. The wire electrical discharge machine has a motor 50 (as described later) for driving an active wheel. Alternatively, the motor 50 can be disposed on the wire-receiving mechanism. In other embodiments, the wire-receiving mechanism 2 also can share a motor inside the wire electrical discharge machine. The wire-receiving mechanism according to this and other following embodiments is applicable in any conventional wire electrical discharge machine and the processing wires of various diameter thereof. As the structures and principles of a wire electrical discharge machines, the processing wires and motors are all well known in the art, a detailed description thereof is omitted.

The wire-receiving mechanism 2 comprises: a case body 21 having a first side 211, an opposed second side 213 and a through hole 2111 disposed in the first side 211; a passive wheel 22 disposed inside the case body 21; an active wheel 23 disposed inside the case body 21 and at one side of the passive wheel 22, the active wheel 23 being capable of causing the passive wheel 22 to rotate; a driving unit 24 disposed to penetrate through the first side 211 of the case body 21, wherein the driving unit 24 has a driving member 241 disposed at the first side 211 principally or entirely outside the case body 21, an action member 243 connected to the driving member 241 via the through hole 2111, and a sliding member 245 connected to the action member 243 for pushing the passive wheel 22; and a pretension spring 26 (which may be a set of springs) disposed at one side of the sliding member 245 and abutted against the sliding member 245 at one end thereof for providing elasticity that allows the passive wheel 22 to move toward the first side 211 of the case body 21.

In the present embodiment, the case body 21 is substantially of a rectangular shape except for the through hole 2111 disposed in the first side 211. The case body 21 also has sliding rails 215 respectively disposed at the top and bottom interior surfaces thereof and opposed to each other. This is the general configuration; however the case body 21 is not limited to the description of the present embodiment.

Either both the passive wheel 22 and the active wheel 23 are eccentric wheels or only one of them is an eccentric wheel. In the present embodiment, the active wheel 23 is axially connected to the case body 21 and one end of the active wheel 23 is connected to the motor 50 of the wire electrical discharge machine. When the motor 50 drives the active wheel 23 to rotate, the active wheel 23 further brings the passive wheel 22 into rotation.

The driving unit 24 is used to drive the passive wheel 22 and control the gap between the passive wheel 22 and the active wheel 23 for holding a processing wire. The driving member 241 can be a servo motor, which is exposed from the first side 211. The action member 243 can be a push rod. The sliding member 245 can be a movable member such as a sliding block, and a sliding slot (not shown) can be disposed in the sliding member 245 to make the sliding member 245 capable of sliding. In the present embodiment, two sliding members 245 are provided and respectively abutted against the upper and lower ends of the passive wheel 22, the sliding members 245 being slidingly disposed on the sliding rails 215 such that the sliding members 245 can move toward the first side 211 or the second side 213. The sliding rails 215 enable more precise movement of the sliding members 25 and avoid jamming of the sliding members 245. It should be noted that the sliding rails can be omitted or replaced by other equivalent members or structures as long as the sliding members 245 can move inside the case body 21.

In the present embodiment, the driving unit 24 further comprises connecting rods 249, one end of the connecting rods 249 being connected to the action member 243 and the other end of the connecting rods 249 being axially connected to the sliding members 245.

One end of the pretension spring 26 is abutted against the sliding member 245 and the other end of the pretension spring 26 is abutted against the second side 213. In the present embodiment, as shown in the drawing, one end of the pretension spring 26 is abutted against one side of the sliding member 245 and the other end of the pretension spring 26 is disposed on or abutted against the inner wall of the second side 213. Also, in the present embodiment, the pretension spring 26 is actually comprised of four springs in two pairs, respectively located on the upper and lower ends of the active wheel 23. It should be noted that the number and location of the springs in the pretension spring 26 is not limited to that disclosed in the present embodiment.

When the driving member 241 drives the action member 243, the sliding member 245 connected to the action member 243 pushes the passive wheel 22 to move close to the active wheel 23 such that the processing wire can be held. Meanwhile, the pretension spring 26 provides pretension for responsively pushing the sliding member 245. Thus, the gap between the active wheel 23 and the passive wheel 22 can be controlled to ensure stable conveying of the processing wire and the holding force can be automatically adjusted. Meanwhile, in that the gap between the passive wheel 22 and the active wheel 23 is adjustable, processing wires of different diameters can be conveniently applied in the process and the overall process time can be reduced.

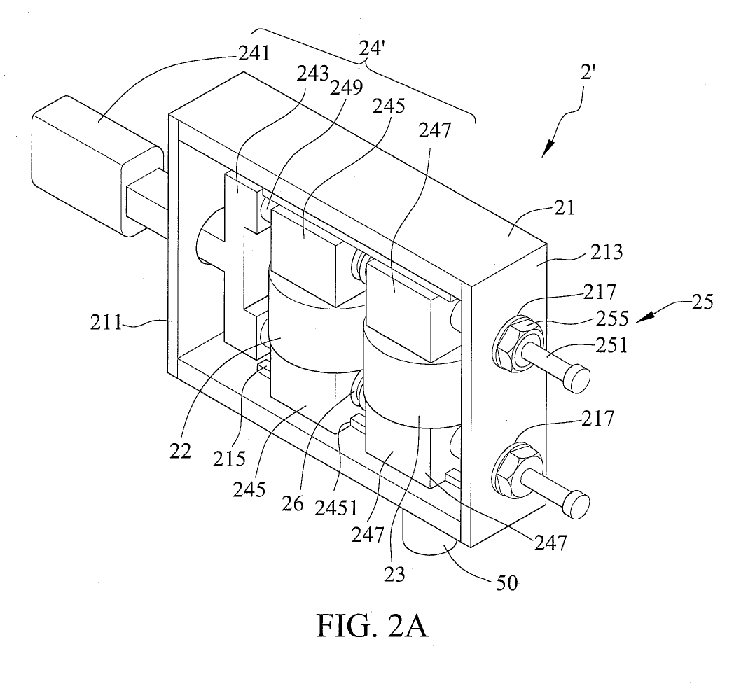

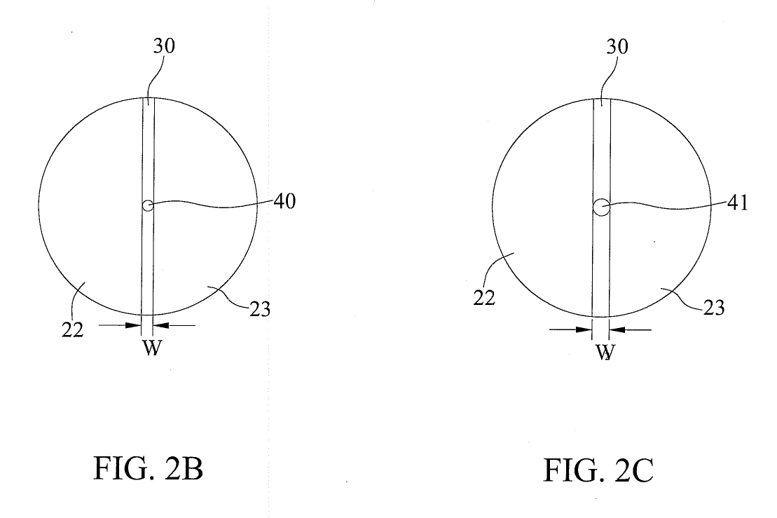

FIGS. 2A to 4B are diagrams showing a wire-receiving mechanism according to another embodiment of the present invention, wherein elements that are the same as or similar to those of the above-described embodiment are denoted by the same or similar numerals for clarity and detailed descriptions thereof are omitted for brevity.

The main difference of the present embodiment from the first embodiment is that the active wheel 23 is not axially connected to the case body 21; that is, the structure of the driving unit 24′ and the disposing method of the active wheel 23 are changed and a status adjusting unit is provided so as to absorb the processing error and assembly error.

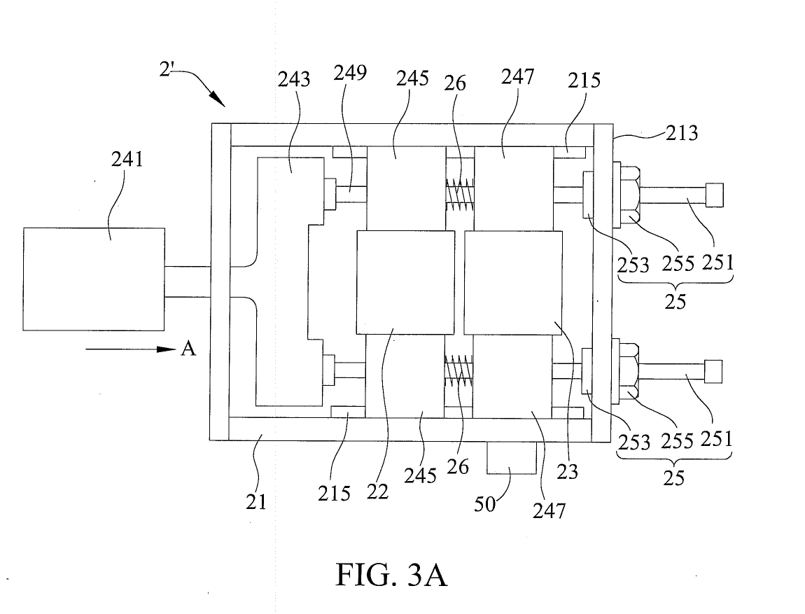

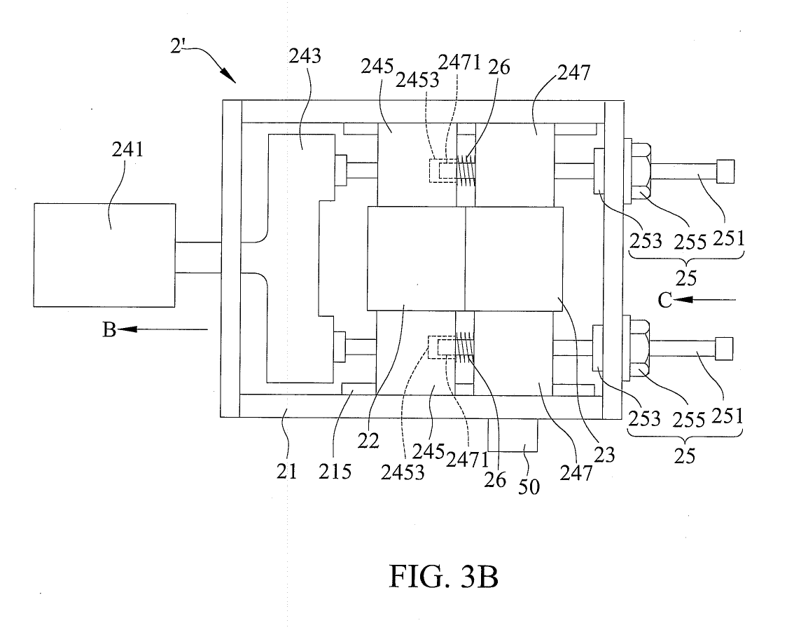

Referring to FIG. 2A, the wire-receiving mechanism 2′ comprises: a case body 21 having a first side 211 and an opposed second side 213; a passive wheel 22 disposed inside the case body 21; an active wheel 23 disposed inside the case body 21 at one side of the passive wheel 22, the active wheel 23 being capable of causing the passive wheel 22 to rotate; a driving unit 24′ disposed to penetrate through the first side 211, wherein the driving unit 24′ has a driving member 241 exposed from the first side 211, an action member 243 connected to the driving member 241, a sliding member 245 connected to the action member 243 for pushing the passive wheel 22, and a micro-movement member 247 axially connected to the sliding member 245 via a connection rod 249 for pushing the active wheel 23 so as to control the gap between the passive wheel 22 and the active wheel 23 such that the processing wire can be held; a status adjusting member 25 disposed at the second side 213, comprising a bolt 251 axially connected to the micro-movement member 247, a fixing nut 253 threaded on the bolt 251 and located inside the second side 213, and an adjusting nut 255 threaded on the bolt 251 and located outside the second side 213 (as shown in FIG. 3A); and a pretension spring 26 disposed at one side of the sliding member 245 and abutted against the sliding member 245 through one end thereof.

The micro-movement member 247 can be a member such as a sliding block. In the present embodiment, two micro-movement members 247 are provided, which are respectively abutted against the upper and lower ends of the active wheel 23 and slidingly disposed on the sliding rails 215. Similar to FIG. 1, the active wheel 23 is fixed after the assembly is finished. But during machining, the micro-movement members 247 are abutted against the active wheel 23 such that the active wheel 23 can slightly move toward the first side 211 or the second side 213. In other words, movement distance of the active wheel 23 is smaller than that of the passive wheel 22.

The case body 21 has a through hole 217 disposed in the second side 213 for disposing the status adjusting unit 25. The connecting rod 249 is axially connected to the action member 243, the sliding member 245 and the micro-movement member 247 (as shown in FIG. 2A). The status adjusting unit 25 is disposed at one side of the micro-movement member 247 for adjusting the micro-movement member 247 so as to make the passive wheel 22 parallel with the active wheel 23, thereby controlling the gap therebetween. In the present embodiment, two status adjusting units 25 are provided, however the invention is not limited thereto. For example, other embodiments could utilize only a single status adjusting unit. The pretension spring 26 is disposed around the connecting rod 249, as shown in FIG. 2A. The fixing nut 253 can be soldered to the inner wall of the second side 213. The adjusting nut 255 is movably disposed on the outer wall of the second side 213 relative to the fixing nut 253. The bolt 251 is disposed to penetrate through the through hole 217 and axially connected to the micro-movement member 247. Of course, the through hole 217 can be replaced by a threaded bolt hole, the status adjusting unit 25 can be disposed to penetrate through the threaded bolt hole with the bolt 251 being fixed by the threaded bolt hole, thereby eliminating the need of the fixing nut 253. The adjusting nut 255 is threaded on the bolt 251 for adjusting the pre-force degree of the bolt 251. The pretension spring 26 is disposed between the sliding member 245 and the micro-movement member 247 for evenly distributing the pushing force. In the present embodiment, the pretension spring 26 is disposed between the sliding member 245 and the micro-movement member 247.

FIG. 2B and FIG. 2C are close-up front views of the wire-receiving mechanism of FIG. 2A, and FIGS. 3A and 3B are action diagrams of the wire-receiving mechanism of FIG. 2A.

As shown in FIGS. 2B and 3A, an external force A is applied to the action member 243 by the driving member 241, which causes the action member 243 to move the sliding member 245 closer to the micro-movement member 247. Thus, the gap 30 between the passive wheel 22 and the active wheel 23 is decreased to a size equal to diameter WI of the processing wire 40 such that the processing wire 40 can be stably held. As shown in FIGS. 2C and 3B, an external force B in a direction opposite to the force A draws the action member 243 so as to make the sliding member 245 move away from the micro-movement member 247. Thus, the gap 30 is adjusted to a size equal to diameter W2 of the processing wire 41 (W2>W1), and accordingly the processing wire 41 can be stably held, as shown in FIG. 2C.

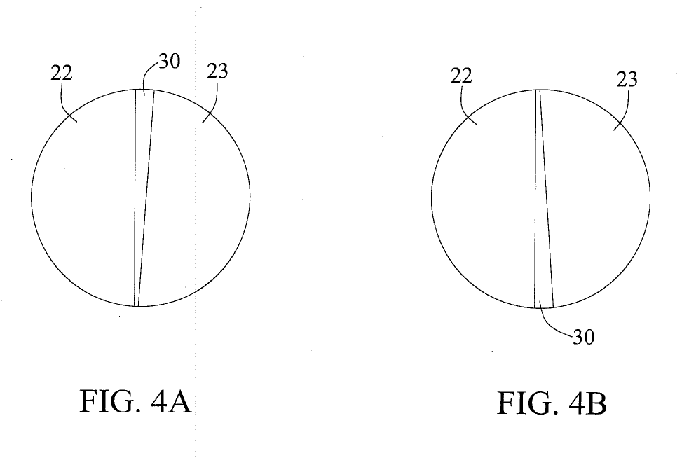

Referring to FIGS. 3B, 4A and 4B, before the processing wire is disposed in the gap 30, if the sliding member 245 is too close to the micro-movement member 247 and the gap 30 has substantially a V-shape, by adjusting the status adjusting unit 25 above the active wheel 23 and the passive wheel 22, the micro-movement member 247 can be in direction C, thus making the wheel surface of the active wheel 23 parallel with that of the passive wheel 22 (the gap 30 having a basically V-shape, as shown in FIG. 4A). On the other hand, if the gap 30 has an inverted V-shape, by adjusting the status adjusting unit 25 below the active wheel 23, the micro-movement member 247 below the active wheel 23 is moved in direction C, thus making the active wheel 23 parallel to the passive wheel 22 (the gap 30 having a basically inverted V-shape, as shown in FIG. 4B).

Thus, by adjusting the micro-movement member 247 through the status adjusting unit 25, the wheel surface of the active wheel 23 can be brought parallel to that of the wheel surface of the passive wheel 22, which thus prevents slipping of the processing wire on the wheel surfaces of the active wheel 23 and the passive wheel 22 when the processing wire is being conveyed, thereby increasing the stability of the wire conveyance.

Further, the wire-receiving mechanism comprises a sliding structure. As shown in FIG. 2A, the sliding structure comprises sliding rails 215 disposed on the top and bottom surfaces of the case body 21 and opposed to each other, and sliding slot 2451 disposed in the sliding members 245. The sliding slot 2451 can be a concave slot. Or, as shown in FIG. 3B, the sliding structure can comprise a pin 2471 disposed on the micro-movement member 247 and a corresponding recess 2453 disposed in the sliding member 245. In other embodiments, the above-described sliding structure can be omitted and an equivalent structure that enables sliding of the sliding member 245 can be applied.

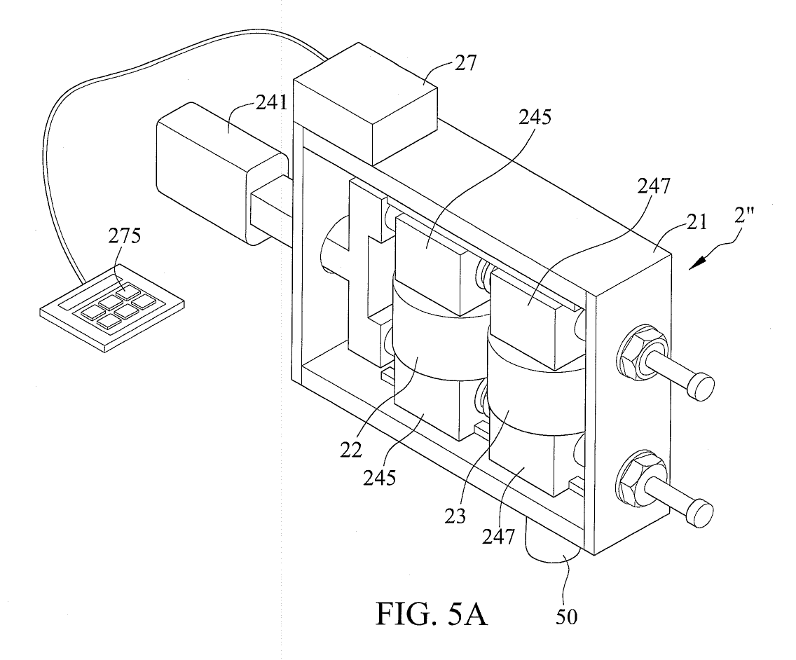

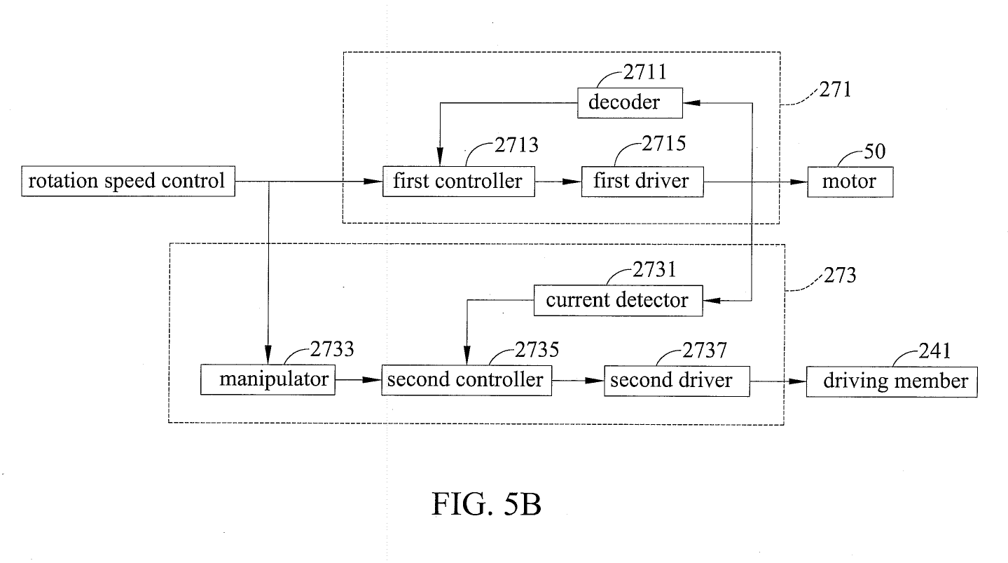

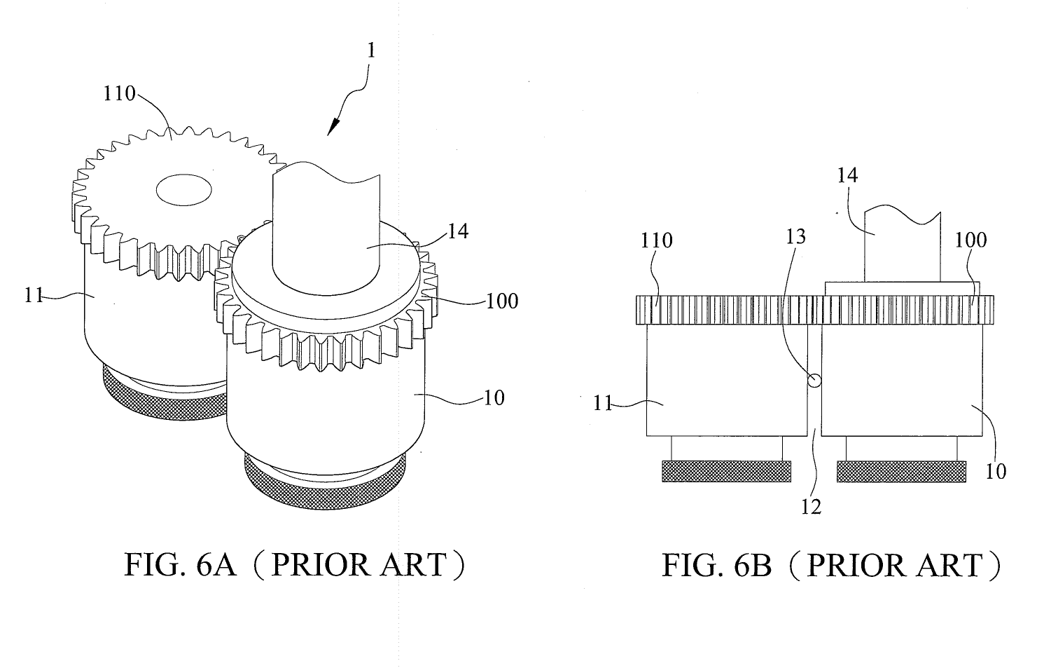

FIG. 5A is a perspective diagram of a wire-receiving mechanism according to another embodiment of the present invention, wherein elements that are the same as or similar to those of the above-described embodiments are denoted by the same or similar numeric designations, detailed description thereof being omitted.

In addition to the elements of the above-described embodiments, a control unit is further provided in the present embodiment for keeping a constant holding force through set control value, thereby automatically controlling the whole process.

Referring to FIG. 5A, the wire-receiving mechanism 2″ has a control unit 27, which is electrically connected to the driving unit 24 or 24′ of the above-described embodiments. In the present embodiment, the control unit 27 is disposed on the top surface of the case body 21 and mechanically and/or electrically connected to the driving member 241. However, the configuration is not limited thereto; the control unit 27 can be disposed inside or outside the case body 21 as long as the control unit 27 can be electrically and/or mechanically connected to the driving unit 24/24′.

Referring to FIG. 5B, the control unit 27 comprises a rotation speed control portion 271 electrically connected to the motor 50 and a holding force control portion 273 electrically and/or mechanically connected to the driving member 241.

The rotation speed control portion 271 has a decoder 2711 that receives the rotation speed signal of the motor 50 and generates a decoding signal, a first controller 2713 that receives the decoding signal and the rotation speed command and generates a control signal, and a first driver 2715 that receives the control signal and drives the motor 50 according to the control signal. The decoder 2711 receives the rotation speed signal from the motor and converts it to a numeric value. The rotation speed command is an input rotation speed value. The first controller 2713 can be, for example, a proportional-integral-derivative controller (PID Controller) that calculates the error between the input rotation speed value and the actual rotation speed value.

The holding force control portion 273 has a current detector 2731 for detecting the current of the motor 50 and generating a current signal, a manipulator 2733 for receiving the rotation speed command and generating a position command, a second controller 2735 for receiving the current signal and the position command and generating a control signal, and a second driver 2737 for receiving the control signal and driving the driving member 241 according to the control signal. The rotation speed command is desired value of the rotation speed of the active wheel 23.

In the present embodiment, the current detector 2731 is directly or indirectly connected with the motor driving line of the first driver 2715 for detecting the actual driving current, thereby calculating the current value required by the desired rotation speed and sending a current signal. The current detector 2731 can be disposed inside the case body 21 or disposed at other positions as long as the current of the motor 50 can be detected. That is, the current detector 2731 that is disposed in the holding force control portion 273 in the present embodiment can be removed from the control unit 27 and alternatively disposed near the motor 50. The manipulator 2733 has a rotation speed-current correspondence table built therein for determining the current value required by the input rotation speed value. The second controller 2735 is used to calculate the error between the current value of the input rotation speed value and the current value of the actual rotation speed value. Since the method of determining the current value corresponding to the input rotation speed value according to the rotation speed-current correspondence table is well known in the art, detailed description thereof is omitted.

Further referring to FIG. 5A, the control unit 27 of the present embodiment comprises an operator interface 275 for inputting the rotation speed command. In other embodiments, the operator interface 275 can be omitted, separately disposed, or integrated with the operator interface of the wire electrical discharge machine (not shown). The operator interface 275 only needs to be electrically connected to the rotation speed control portion 271 and the holding force control portion 273 of the control unit 27 for providing a rotation speed command.

Referring to FIG. 5B, a rotation speed command can be input to the rotation speed control portion 271 during machining of a work piece. The first controller 2713 receives the rotation speed command (such as the input rotation speed value) and the decoded signal supplied by the decoder 2711 (for example the actual value of the rotation speed of the motor 50) after receiving it converts it from a feedback signal related to rotation speed. Thus, any error between the input rotation speed value and the actual value of the rotation speed can be obtained. The first controller 2713 calculates the error so as to obtain a rotation control command, converts the rotation control command to a control signal, and inputs the control signal to the first controller 2715 to drive the motor 50 to operate, thus, a determined rotation speed can be reached.

Meanwhile, the rotation speed command is input to the holding force control portion 273, and the manipulator 2733 determines the current value required for the input rotation speed value according to the rotation speed-current correspondence table and transfers the current value to the second controller 2735. Meanwhile, the current detector 2731 transfers the detected actual current value of the motor 50 to the second controller 2735. Thus, any error between the desired current value and the actual current value can be calculated so as to obtain a movement control command. The movement control command is further transferred to the second driver 2737 to drive the driving member 241 to operate. Thus, a determined holding force can be reached.

Therefore, by adjusting the lateral (back-and-forth) position of the driving member 241 through the holding force control portion 273, the holding force applied to the action member 243 as well as the sliding member 245 can be changed, thereby causing the sliding member 245 to slide toward or away from the micro-movement member 247 and further causing the passive wheel 22 to move closer to or away from the active wheel 23. Thus, the gap between the passive wheel 22 and the active wheel 23 is adjusted.

Therefore, the present invention controls the gap between the active wheel and the passive wheel through the driving unit so as to generate a suitable holding force such that a cutting process wires can be stably conveyed. Meanwhile, a suitable holding force can efficiently protect the cutting process wire from breaking. Further, by adjusting the micro-movement member through the status adjusting unit, the assembly error and the processing error can be absorbed so as to keep wire conveyance stable. Also, the pre-tension spring can provide pretension for controlling operation of the mechanism through the control unit. Therefore, the present invention provides an even and stable holding force that ensures a stable wire conveyance. Meanwhile, wires of different diameters can be applied in a same process by automatically adjusting the gap between the active wheel and the passive wheel. Thus, the present invention improves the process convenience, ensures efficient and stable wire conveyance and saves process time and cost.

The above-described descriptions of the detailed embodiments are only to illustrate the preferred implementation according to the present invention, and are not intended to limit the scope of the present invention. Accordingly, various modifications and variations attainable by those with ordinary skill in the art are possible that fall within the spirit and the scope of the present invention as defined by the appended claims.

What is claimed is:

1. A wire-receiving mechanism for holding the processing wire of a wire electrical discharge machine, comprising:
a case body having a first side and an opposed second side;
a passive wheel disposed inside the case body;
an active wheel disposed inside the case body at one side of the passive wheel, the active wheel being capable of causing the passive wheel to rotate;
a driving unit disposed to penetrate through the first side of the case body, wherein the driving unit has a driving member disposed at the first side, an action member connected to the driving member, and a sliding member connected to the action member for pushing the passive wheel, thereby controlling the gap between the passive wheel and the active wheel for holding the processing wire; and
a pretension spring disposed at one side of the sliding member and abutted against the sliding member through one end thereof so as to provide elasticity that allows the passive wheel to move toward the first side of the case body.

2. The wire-receiving mechanism of claim 1 further comprising a sliding structure that allows the sliding member to slide.

3. The wire-receiving mechanism of claim 2, wherein the sliding structure comprises sliding rails respectively disposed on the top and bottom interior surfaces of the case body and opposed to each other, and a sliding slot disposed in the sliding member.

4. The wire-receiving mechanism of claim 2 further comprising a micro-movement member axially connected to the sliding member, wherein the sliding structure comprises a pin disposed in the micro-movement member and a recess disposed in the sliding member.

5. The wire-receiving mechanism of claim 1, wherein the active wheel is axially connected to the case body.

6. The wire-receiving mechanism of claim 1, wherein the driving member is a servo motor, the action member is a push rod, and the sliding member is a sliding block.

7. The wire-receiving mechanism of claim 1, wherein the driving unit has a connecting rod, one end of which is connected to the action member and the other end of which is axially connected to the sliding member.

8. The wire-receiving mechanism of claim I further comprising a micro-movement member axially connected to the sliding member.

9. The wire-receiving mechanism of claim 8, wherein the micro-movement member is a sliding block.

10. The wire-receiving mechanism of claim 8, wherein the driving unit has a connecting rod, which is axially connected to the action member, the sliding member and the micro-movement member.

11. The wire-receiving mechanism of claim 1 further comprising a status adjusting unit disposed at the second side of the case body.

12. The wire-receiving mechanism of claim 11 further comprising a micro-movement member axially connected to the sliding member, wherein the status adjusting unit is disposed at one side of the micro-movement member for adjusting the micro-movement member so as to make the passive wheel and the active wheel parallel with each other.

13. The wire-receiving mechanism of claim 12, wherein the status adjusting unit comprises a bolt axially connected to the micro-movement member, a fixing nut threaded to the bolt and located inside the second side of the case body, and an adjusting nut threaded to the bolt and located outside the second side of the case body.

14. The wire-receiving mechanism of claim 1 further comprising a micro-movement member axially connected to the sliding member, wherein the pretension spring is disposed between the sliding member and the micro-movement member.

15. The wire-receiving mechanism of claim 14, further comprising a bolt hole and a status adjusting unit disposed at the second side of the case body, the status adjusting unit comprises a bolt axially connected to the micro-movement member and fixed by the bolt hole, and an adjusting nut threaded on to the bolt and located outside the second side.

16. The wire-receiving mechanism of claim 1, further comprising a control unit electrically connected to the driving unit.

17. The wire-receiving mechanism of claim 16, wherein the wire electrical discharge machine comprises a motor for driving the active wheel, and the control unit comprises a rotation speed control portion electrically connected to the motor and a holding force control portion electrically connected to the driving member.

18. The wire-receiving mechanism of claim 17 further comprising an operation interface electrically connected to the control unit for providing a rotation speed command, wherein the rotation speed control portion comprises a decoder for receiving the rotation speed signal of the motor and generating a decoding signal, a first controller for receiving the decoding signal and the rotation speed command and then generating a control signal based on their difference, and a first driver for receiving the control signal so as to drive the motor.

19. The wire-receiving mechanism of claim 18, wherein the first controller is a proportional, integral, derivative controller (PID Controller).

20. The wire-receiving mechanism of claim 17 further comprising an operation interface electrically connected to the control unit, the operation interface being used to provide a rotation speed command, wherein the holding force control portion comprises a current detector for detecting the motor current and generating a current signal, a manipulator for receiving the rotation speed command and then generating a position command, a second controller for receiving the current signal and the position command and then generating a control signal, and a second driver for receiving the control signal so as to drive the driving member.
